(19) United States
(12) Patent Application Publication
(10) Pub. No.: US 2004/0160596 A1
(43) Pub. Date: Aug. 19, 2004

(54) Apparatus and method to accurately monitor signal quality in optical signal transmission systems

(75) Inventors: Qing He, Fremont, CA (US); Zhouzheng Shi, Union City, CA (US); Yuanxiang Wu, San Jose, CA (US)

Correspondence Address: Bo-In Lin, 13445 Mandoli Drive, Los Altos Hills, CA, 94022, US

(73) Assignee: PACTONIX, Inc.

(21) Appl. No.: 10/368,929

(22) Filed: Feb. 19, 2003

(51) Int. Cl. G01N 21/00

(52) U.S. Cl. 356/73.1

(57) ABSTRACT

The design and apparatus constitutes the present invention allows for accurate analysis of optical signal quality such as wavelength, signal power and optical signal to noise ratio (OSNR) in ITU wavelength based dense wavelength division multiplexing fiber optical transmission system by using a optical tunable filter, a wavelength self-referencing system and a multi-channel optical power attenuation filter and detecting simultaneously or successively signal and noise separately in routing signal into one detection arm and noise into a signal attenuated detection arm. The tunable filter can be either a transmissive or a reflective device, which can be tuned across the wavelength band by way of control signal. The present invention advantageously supply a technique to measure accurately the optical signal power and optical noise level.

### FIELD OF THE INVENTION

This invention relates generally to a system configuration and method for monitoring optical signal quality in optical signal transmission systems. More particularly, this invention relates to an apparatus and method to accurately monitor the optical signal quality in the dense wavelength division multiplexed (DWDM) fiber optical transmission systems.

### BACKGROUND OF THE INVENTION

Conventional techniques of measuring the quality of optical signals including the measurements of the optical power, the peak wavelength, and the optical signal-to-noise-ratio (OSNR) for each channel of a DWDM network are confronted with several technical difficulties. Specifically, the conventional technology has difficulties to accurately measure the signal amplitude in each channel due to either the spectral shifts or narrow bandwidth tunable filter. The spectral shift may cause an offset of the peaks representing the channel signal amplitude to deviate from the central wavelength in each channel and that results in deviations in signal amplitude measurements. The optical spectra of modulated laser has much wider bandwidth compared to non-modulated laser, so the narrow bandwidth tunable filter usually fails to accurately measure the total power of each channel. Furthermore, it is often difficult to accurately measure the noise level in each channel mainly due to adjacent channels power leakage, in other word, the noise power detected contains a portion of signal power from adjacent channels, this portion of signal power can not be accurately subtracted, therefore the noise measure doesn't reflect the true noise level.

These technical challenges and difficulties may hinder further developments of applying fiber networks for telecommunications. Particularly, the next generation networks must accommodate the ever-increasing demands for more bandwidth. A common solution is to increase the bandwidth of the optical fibers by increasing the transmission rate for each channel and/or reducing the channel separation. Bandwidth constraints have also prompted the need for greater network flexibility that will transform today's point-to-point and ring structures to more mesh-like topologies. The changing demands of customers require that networks must be easily re-configurable.

In order to satisfy the requirement to flexibly reconfigure the network, there are trends of developing three major types of optical devices for driving the functionality of optical fiber networks. These three major types of optical devices include the tunable optical add/drop multiplexer, tunable lasers, dynamic gain equalizers. However, to control these new easily re-configurable networks, it is essential to provide fast and accurate optical spectral measurement of each channel at locations distributed across the entire networks. Also from a service provider's perspective, in order to maximize the revenue, service providers need to minimize the operations cost per bit, while still maintaining the quality of service those customers require. Thus, it is important for networks operators to have instrumentation distributed over the network for monitoring the transmissions of signals to immediately detect when the transmission of signals in the networks is not operating according to its required specifications. Continuous monitoring of the signal quality in transmission over the networks provides critical input for protection switching, channel power equalization, and span monitoring of signal transmissions. With a well-monitored network the service provider can take the necessary actions before transmission errors start to occur.

In order to fulfill the need of network monitoring functions, the Optical Signal Quality Monitor (OSQM) devices are used to measure the optical power, the peak wavelength, and the optical signal-to-noise-ratio (OSNR) for each channel of a DWDM network. The monitoring devices are distributed in the networks to detect, identify and localize faults and deviations from specifications in the networks. When the spectral analysis is performed fast enough, it is also possible to use the monitoring devices to generate alarms for protection switching.

However, due to the wavelength shifts in the normal course of system operations, particularly for high bandwidth operations, there is still a need in the art of design and manufacture of optical signal transmission monitoring devices to provide accurate signal measurements to resolve the technical difficulties and limitations as now faced by the conventional technologies.

### SUMMARY OF THE PRESENT INVENTION

It is therefore an object of the present invention to provide a new method and configuration for monitoring the optical signals in fiber networks with improved flexibility, control and accuracy such that the above-mentioned difficulties and limitations may be overcome.

Specifically, it is an object of the present invention to provide a new technique implemented with a new configuration for analyzing optical spectrum in the wavelength domain of ITU DWDM fiber optic system to accurately measure the wavelength, power and OSNR of optical signal for each channel.

The design and apparatus forming the present invention allows for rapid analysis of the optical spectrum and its contents by controlling the spectral position of optical tunable filter and using a wavelength self-referencing system and a multi-channel optical power attenuation filter (MCOPAF).

Briefly, in a preferred embodiment, the present invention discloses an optical band selection system, a wavelength measuring system, a channel power detection system, and an optical noise detection system. More specifically, this invention discloses an apparatus for analyzing an optical channel performance of a fiber optic system. The apparatus includes a wavelength reference system having a broadband source connected to a narrow bandwidth notch filter for generating a notched spectrum having a notched optical power over a specific rang of wavelengths for providing a reference of wavelength measurement for the apparatus. In another preferred embodiment, the apparatus further includes an optical 2×1 switch to alternate between an input fiber and the broadband source for comparing two alternate measurements obtained in two alternate switching conditions of the 2×1 switch for using the wavelength reference system. In another preferred embodiment, the apparatus further includes an optical wavelength dependent tunable filter having an input and output. The apparatus further includes a detection system for detecting a wavelength, power and optical noise of an optical signal providing from the optical output of the optical tunable filter. And, the output of the tunable filter splitted into at least into two branches wherein a first branch is for measuring a channel optical power and wavelength and a second branch further includes an optical channel power attenuation means for measuring an optical noise.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

The design and apparatus for optical signal quality monitoring in dense wavelength division multiplexing fiber optic transmission system forming the present invention will be described now, by example only, referring to the accompanying drawings, in which:

FIG. 1 is the system block diagram of wavelength, optical power and optical noise level measurement of the present invention.

FIG. 2 is a detailed drawing of the optical circuit of the optical signal quality monitoring system of the present invention, which includes optical band selector built with a circulator, N×1 switch and several fiber Bragg grating based band reflectors.

FIG. 3 is a typical transmission spectrum of multi-channel optical power attenuation filter (MCOPAF).

FIG. 4 is a typical optical spectrum measured by a second detector for wavelength reference with a missing peak as the wavelength highly attenuated by the notch filter, other peak wavelengths are ITU wavelength offset by 12.5 or 25 or 50 GHz provided by the multi-channel optical power attenuation filter (MCOPAF).

FIG. 5 is typical optical spectrum from the input fiber recorded simultaneously on both photo detectors, the upper curve is used to determine both channel power and wavelength, the bottom curve is used to determine the optical noise level of each channel.

FIG. 6 is another embodiment of the optical signal quality monitoring system of the present invention wherein the input optical signal containing only one predefined optical band to be scanned.

FIG. 7 is an alternative design described in FIG. 6.

FIG. 8 is another alternative design integrating a second N×1 switch to accommodate multiple optical signal inputs.

FIG. 9 is simplified design described in FIG. 2 by implemented without the wavelength reference system thus the measurement accuracy depends mostly on the repeatability of wavelength tuning of the optical tunable filter.

FIGS. 10, 11 and 12 are alternate embodiments of optical signal quality monitoring system with multi-channel optical power attenuation filter (MCOPAF) for accurate analyses of optical signal quality such as wavelength, signal power and optical signal to noise ratio (OSNR).

### DETAILED DESCRIPTION OF THE PREFERRED EMBODIMENT

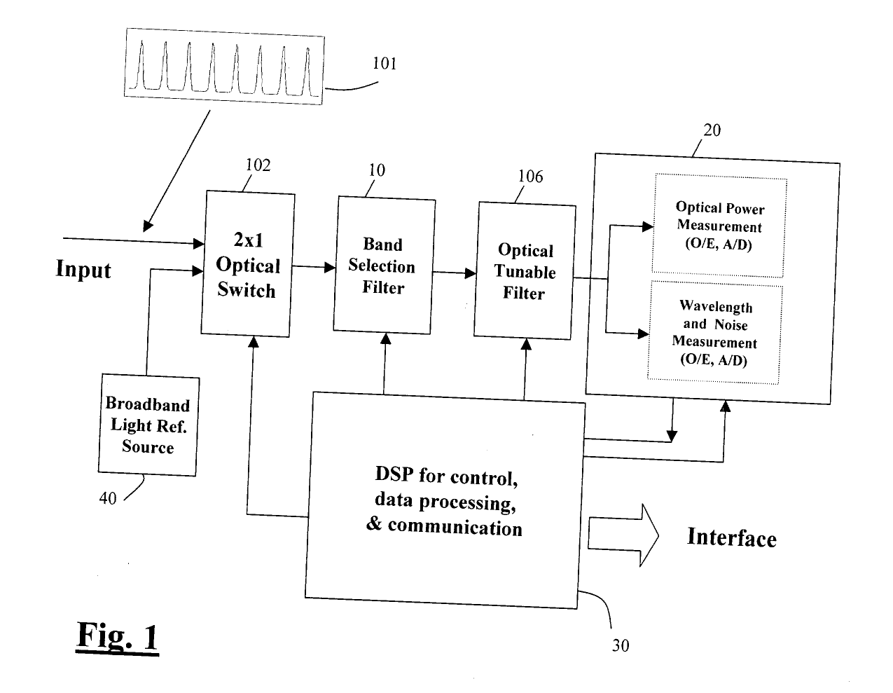

Referring to FIG. 1 for a functional block diagram for showing an optical signal monitoring system as a preferred embodiment of the present invention. The optical signal monitoring system as configured can be applied for monitoring the optical signal quality for a dense wavelength division multiplexing (DWDM) system. An input optical signal 101 is received into the monitoring system through an input optical fiber connected to a 2×1 optical switch 102. The optical switch 102 switches alternately between the input optical fiber and a broadband reference light source 40. The reference light source is applied for calibration of the optical tunable filter 106 and once the calibration is completed the spectral positions of the peak wavelengths within the selected wavelength band of the input signal can be more accurately determined. The wavelength band selection is carried out by the band selection filter 10 to select the optical band to be scanned with minimum loss. An optical tunable filter 106 is implemented to transmit optical signal of selective wavelengths to a wavelength power and noise measurement device 20 to perform a quality of optical signal measurements including the measurements of wavelengths, the optical powers in each channel and signal to noise ratios. A digital signal processor (DSP) controller 30 is implemented to perform controls, data acquisition, data processing and communications. As shown in FIG. 1, an optical signal monitoring system is provided based on the use of optical tunable filter together with a wavelength reference system and power determination system to provide accurate wavelength, power and optical signal to noise ratio measurement for each channel with the channels divided according to the International Telecommunication Union (ITU) grids.

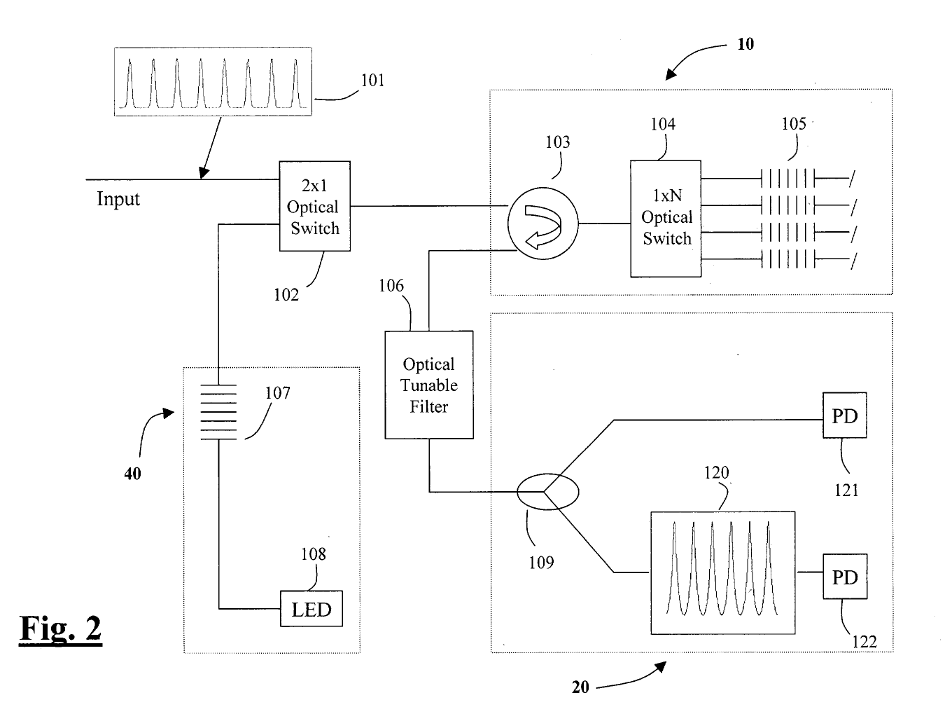

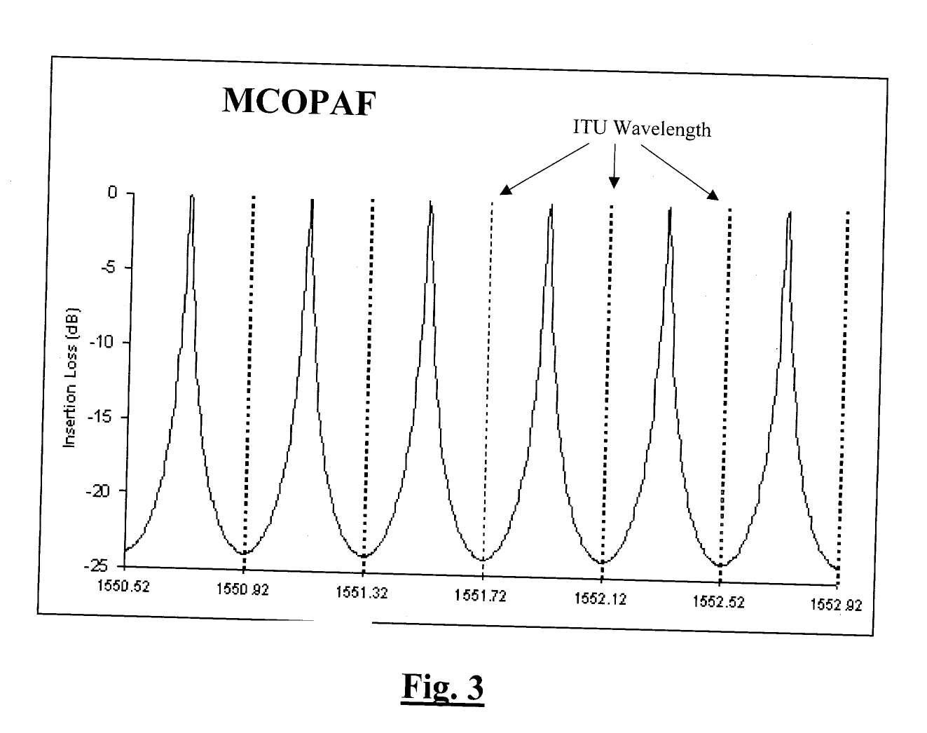

Referring to FIG. 2 for a functional block diagram showing more specific implementation of the optical signal monitoring system according to FIG. 1. After the input optical signal 101 passes through the optical switch 102, it is projected through a three-port circulator 103 for transmitting to a 1×N optical switch 104. The 1×N optical switch is used to select one of reflectors 105. Each reflector, based on the broadband fiber Bragg grating (FBG) 105, covers a selected range of wavelengths and reflects back all light within the range to be scanned by the optical signal quality monitoring system and eliminates optical signals and noise outside of the selected wavelength range. The broadband FBG reflector 105 provides high reflectivity and high reflection uniformity. The optical signals within the selected range of wavelengths are reflected from band selector 10 then routed through the three-ports circulator 103 into optical tunable filter 106 for carrying out a channel scanning operation sweeping through all channels. The optical signals in each channel are transmitted to a beam splitter 109 to project to a spectrum measurement system 20. The optical signals are projected to a first photo-detector 121 for the channel wavelength and power measurement and to a second photo-detector 122 through a periodic comb filter configured as a multi-channel optical power attenuation filter (MCOPAF) 120. Referring to FIG. 3, the attenuation peaks of MCOPAF are aligned to ITU grid wavelengths to maximize the signal power attenuation and let the noise signals pass between the ITU wavelengths. The second photo-detector 122 is applied to measure the optical spectral power at the middle point between the ITU channels to accurately measure the noises transmitted in each channel.

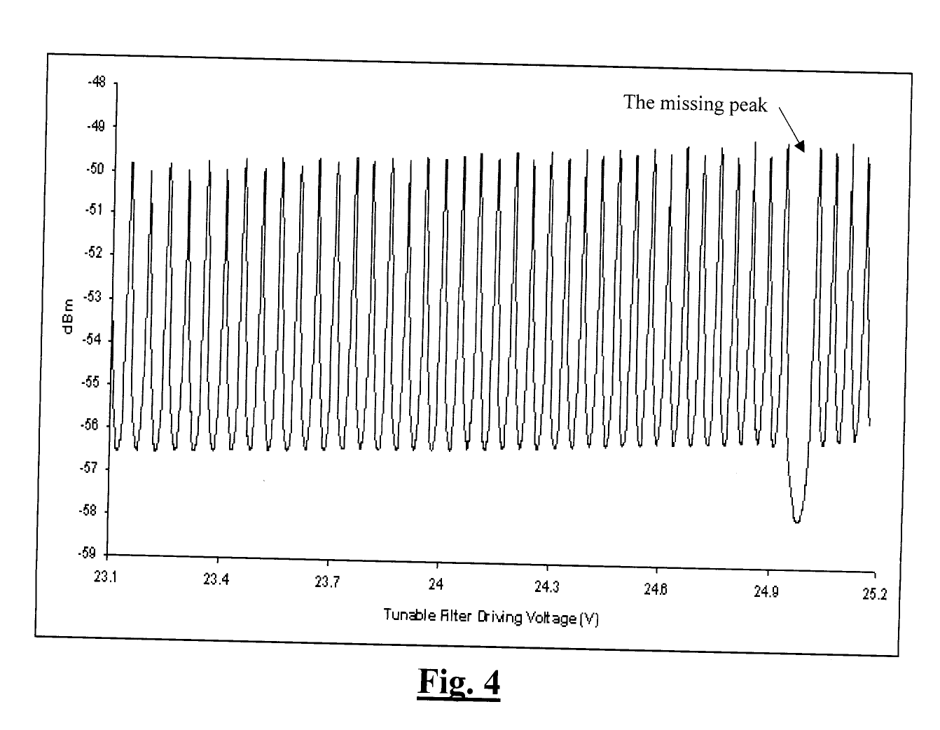

Referring to FIG. 2, FIG. 3 and FIG. 4 for the technique used to calibrate the optical tunable filter 106 by establishing the correlation between the transmission peak wavelength and the driving voltage. A light emitting diode (LED) source 108 is a continuous broadband light source for emitting a light over a continuous broadband spectrum to pass through a notch filter 107 that is a narrow bandwidth high reflection fiber Bragg grading filter to eliminate a predefined narrow range of the spectrum emitted from the LED source. This predefined narrow range of the notched spectrum is overlapped with a one of MCOPAF's transmission peaks in the wavelength domain and the optical transmission over all other peaks is unaffected as that shown in FIG. 4. The missing peak is the wavelength highly attenuated by the notch filter 107 and other peak wavelengths are ITU wavelengths offset by 12.5 or 25 or 50 GHz. By adjusting the voltage applied to the optical tunable filter 106 to sweep over the entire spectrum, each peak shown in FIG. 4 is corresponding to one driving voltage, Therefore, assuming the correlation between two neighboring peaks is a linear relation, a calibration of the optical tunable filter 106 is established with measurements using the notched spectrum shown in FIG. 4 to specifically define a correlation of the voltage applied to the tunable filter versus its transmission wavelength over specific range of spectrum range. This calibration process using the reference LED light source 108, the notch filter 107 and the MCOPAF 120 is carried out before a measurement of optical power and channel noise by switching the 2×1 switch to the input optical signal. This calibration process thus significantly reduces the measurement uncertainties and deviations of wavelength caused by environmental factors such as wavelength shifts due to temperature variations. By adding of MCOPAF 120 before the second detector allows to use optical tunable filter with a large full-width at half-maximum (FWHM) having a low rejection at adjacent channels to achieve accurate power and OSNR measurement without implementing complicated and inaccurate curve fitting and de-convolution calculations thus greatly improve the accuracy of optical signal measurements when compared to conventional techniques that uses narrow FWHM with high rejection tunable filters.

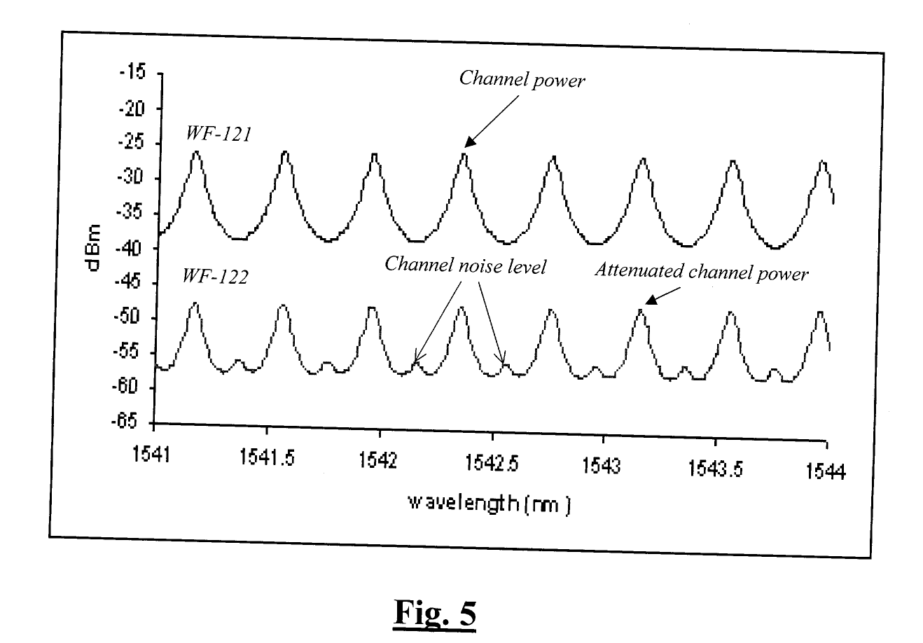

Referring to FIG. 5 for two typical waveforms WF-121 and WF-122 measured by two photo-detectors 121 and 122. Since the optical signals WF-122 measured by the photo-detector 122 are processed by a multi-channel optical power attenuation filter (MCOPAF) 120, the peak power in each channel is attenuated therefore the peak power of WF-122 is much lower than WF-121 as measured by the photo-detector 121. Meanwhile, there are small peaks WFN-122 measured by the photo-detector 122 as small peak signals between the channel peaks. The small peaks WFN-122 represent noises in each channel that pass through the attenuation filter 120 with minimum attenuation.

As discussed above, the system configuration and methods of wavelength calibrations and noise measurements allow for accurate measurements and analyses of DWDM optical spectrum. With the 2×1 optical switch, the tunable filter 106 implemented for scanning through channels over the entire spectrum can be continuously calibrated to assure wavelength measurement accuracy. By adding of MCOPAF 120 before the second detector allows the use of large FWHM optical tunable filter with low rejection at adjacent channels to achieve accurate power and OSNR measurement without implementing complicated and inaccurate curve fitting and de-convolution calculations thus greatly improve the accuracy of optical signal measurements. The noise measurements performed by photo-detector 122 is more accurate because the noise signals are measured with very low leaked power from any signal channel. The optical signal quality monitoring system as disclosed in FIG. 2 provides flexibility, convenience and accuracy of measurements to perform real time calibrations and to more accurately measure both the channel power and channel noise signals.

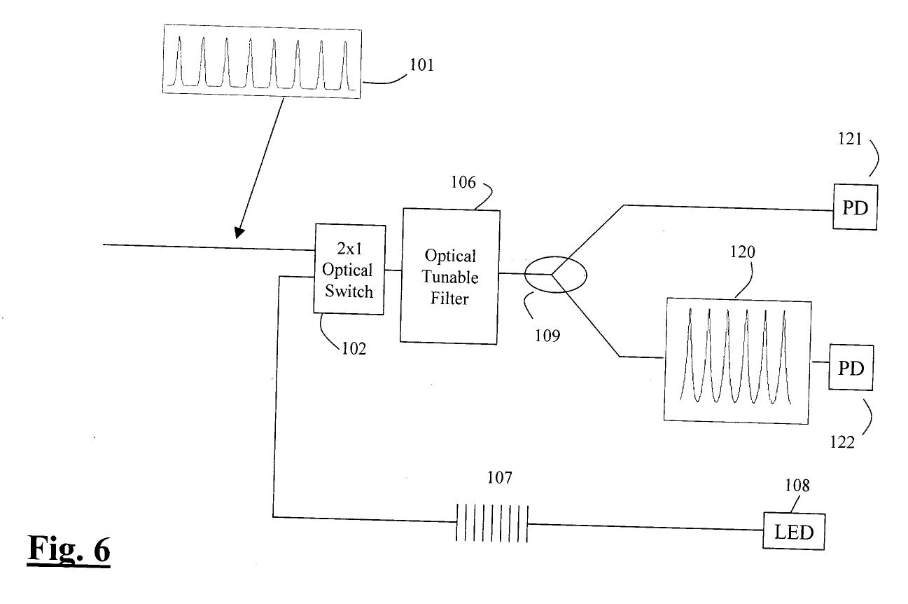

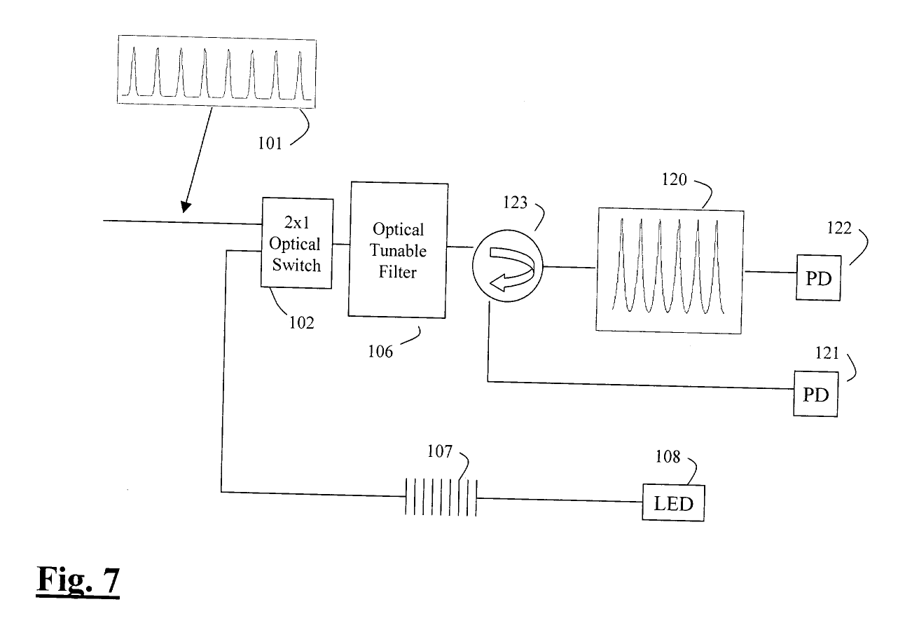

FIG. 6 is a functional block diagram showing an alternate embodiment of the optical signal quality monitoring system of this invention similar to that shown in FIG. 2 without a band selection. The monitoring system is applied for single band application. FIG. 7 shows another optical signal quality monitoring system similar to FIG. 6 by replacing the beam splitter 109 with a circulator 123 to reduce the insertion losses of the optical signals transmitted to the photo-detectors 121 and 122.

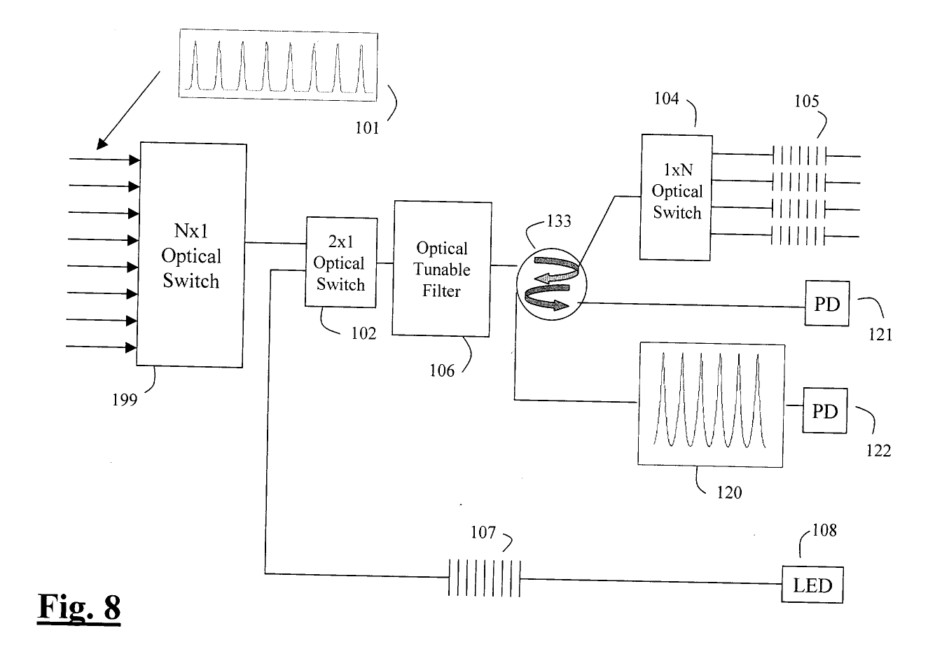

Referring to FIG. 8 for an alternate embodiment of FIG. 2 by using a four-port circulator 133 to replace the beam splitter 109 and the three-port circulator 103 thus simplifying the monitoring system. The insertion loss is reduced and meanwhile an N×1 switch is added at input to accommodate multiple inputs for monitoring the optical signal quality of the optical signals transmitted in several different transmission paths.

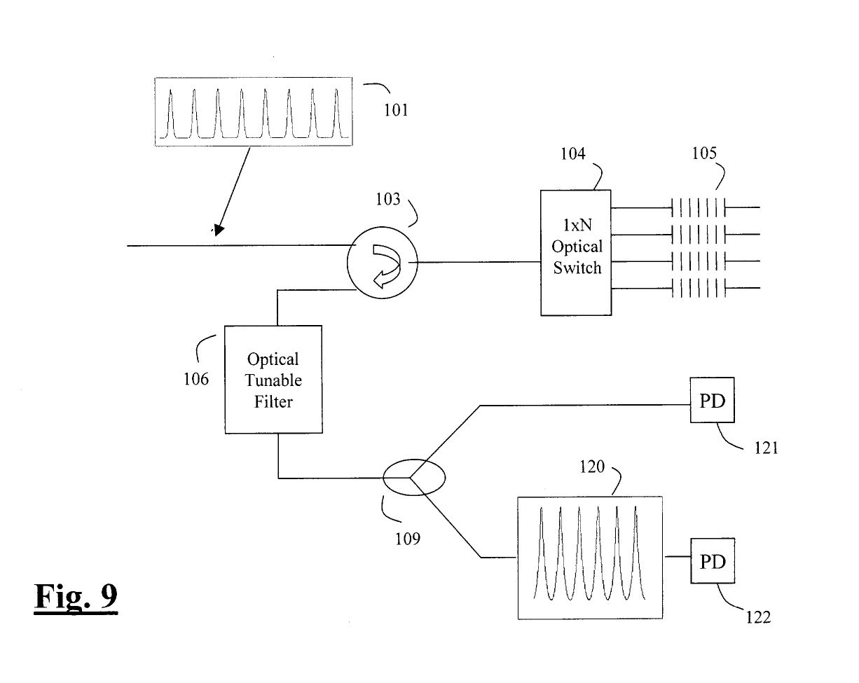

FIG. 9 is a simplified design described in FIG. 2 by removing the wavelength reference system for calibrating the optical tunable filter 106. The accuracy of the wavelength measurements depends more heavily on the accuracy and performance repeatability of the optical tunable filter 106.

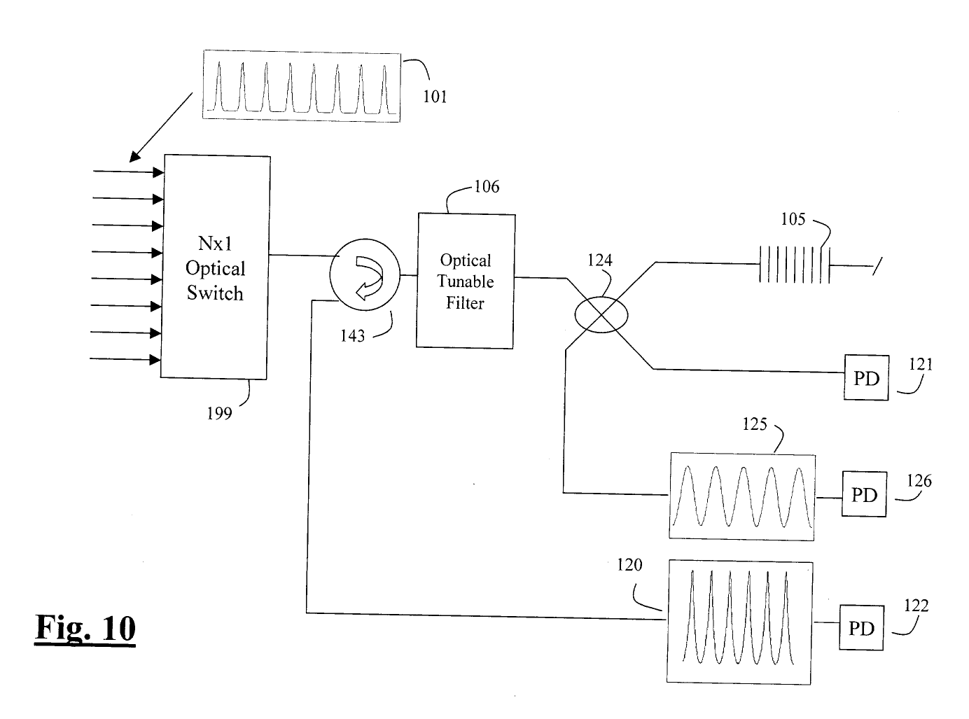

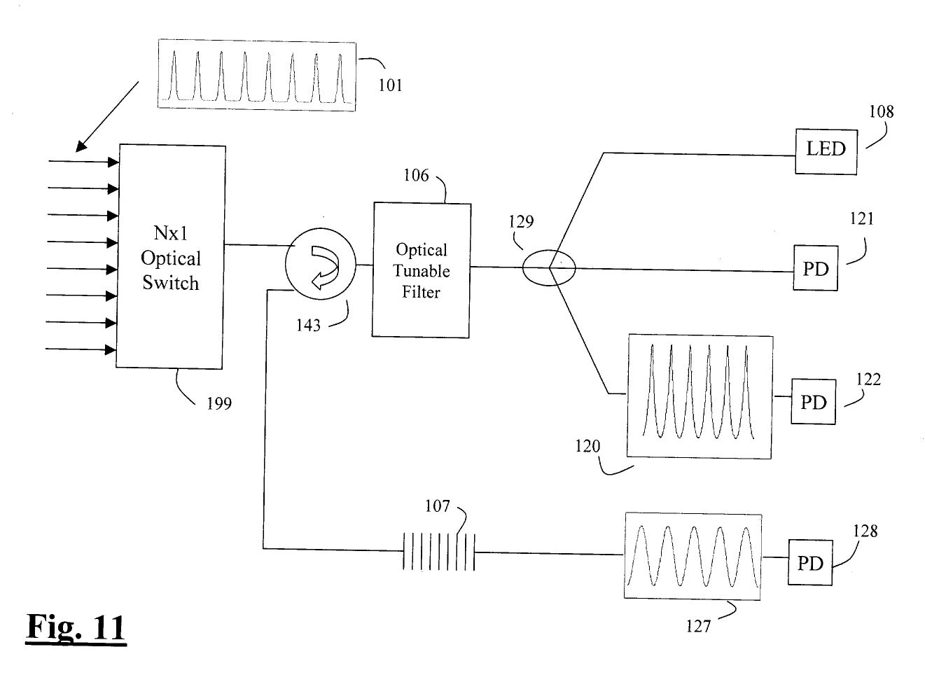

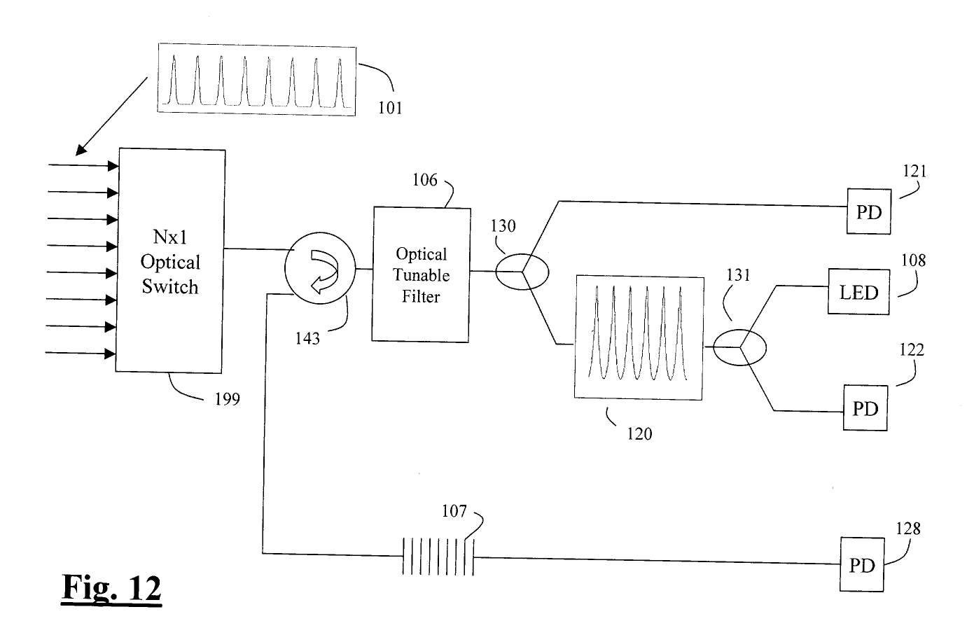

FIG. 10 is another optical signal quality monitoring system with simultaneous wavelength measuring system of this invention. The N×1 optical switch 199 is provided to selected one input optical signal among N optical fibers connected to the switch 199. The selected optical signal passes through a circulator 143 and an optical tunable filter for selecting a band and for determination of the channel powers by applying the photo-detector 121. The photo-detector 121 is also calibrated by comparing the channel powers measured by the photo-detector 121 and 126. The input signal passes through a periodic Fabry-Perot comb filter 125. The transmission curve is similar to a SIN-wave function with the middle points of slope aligned to each ITU wavelength. Comparisons between the peak powers detected by the photo-detector 121 and 126 enables the calculations to accurately determine the wavelength of each channel thus enabling a precise determination of the channel powers and channel wavelength from measurements obtained by the photo-detectors 121 and 126. In the meantime, the optical signal reaches the photo-detector 122 passes twice through the tunable filter 106 and causes a nearly 50% reduction of the bandwidth of the tunable filter therefore increasing the rejection of the signal power to reach the photo-detector 122 such that the noises in each channel can be more accurately measured. FIG. 11 shows another alternate embodiment similar to that shown in FIG. 8 without band selection. FIG. 12 shows an alternate embodiment of a monitoring system of this invention as that shown in FIG. 11. In order to accurately analyze optical signal quality such as wavelength, signal power and optical signal to noise ratio (OSNR), all design have a multi-channel optical power attenuation filter (MCOPAF) 120.

According to above descriptions, this invention discloses an optical signal quality monitoring system for monitoring an optical signal transmitted over an optical transmission system. The optical signal quality monitoring system includes a means for providing a calibration-spectrum for comparing with a measurement of the optical signal monitored for the optical transmission system for calibrating the measurement of the optical signal monitored for the optical transmission system. In a preferred embodiment, the means for providing a calibration-wavelength further comprising a standard light source and a notch filter for providing the calibration wavelength for comparing with the measurement of the optical signal monitored for the optical signal transmission system. In another preferred embodiment, the optical signal quality monitoring system further includes a first optical signal detecting means for measuring the optical signal monitored for the optical signal transmission system, and a second optical signal detecting means for measuring the calibration-spectrum. In another preferred embodiment, it further includes an optical switching means for transmitting alternate optical signals to the first and the second optical signal detection means. In another preferred embodiment, the optical signal quality monitoring system further includes a noise signal detecting means having an optical signal attenuation means for attenuating a portion of the optical signal monitored for the optical signal transmitting system for measuring the noise signal. In another preferred embodiment, the optical signal quality monitoring system further includes a spectrum-band selection means for selecting a band of spectrum of the optical signal monitored for the optical signal transmitting system. In another preferred embodiment, the optical signal quality monitoring system further includes an optical tunable filter for tuning and scanning over a plurality of wavelength-channels for detecting a quality of the optical signal for each of the wavelength-channels of the optical signal monitored for the optical signal transmitting system. In another preferred embodiment, the optical signal quality monitoring system further includes a noise signal detecting means having an optical signal attenuation means constituting a comb-attenuating filter for attenuating a peak of a plurality of wavelength-channels of the optical signal monitored for the optical signal transmitting system for measuring the noise signal. In another preferred embodiment, the means for providing the calibration-wavelength further comprising a calibrated Fabry-Perot comb filter wherein the comb filter is calibrated according to a relative insertion loss versus wavelengths and having a transmission curve similar to a SIN-wave function with a slope of middle points aligned to a standard ITU wavelength grid.

This invention further discloses an apparatus for analyzing an optical channel performance of a fiber optic system. The apparatus includes a wavelength reference system having a broadband source connected to a narrow bandwidth notch filter for generating a notched spectrum having a notched optical power over a specific rang of wavelengths for providing a reference of wavelength measurement for the apparatus. In another preferred embodiment, the apparatus further includes an optical 2×1 switch to alternate between an input fiber and the broadband source for comparing two alternate measurements obtained in two alternate switching conditions of the 2×1 switch for using the wavelength reference system. In another preferred embodiment, the apparatus further includes an optical wavelength dependent tunable filter having an input and output. The apparatus further includes a detection system for detecting a wavelength, power and optical noise of an optical signal providing from the optical output of the optical tunable filter. And, the output of the tunable filter splitted into at least into two branches wherein a first branch is for measuring a channel optical power and a second branch further includes an optical channel power attenuation means for measuring an optical noise and wavelength. In another preferred embodiment, the apparatus further includes an optical channel power attenuation filter constituting a periodic Fabry-Perot filter with attenuated peaks matching a plurality of ITU channels and each of transmitted peaks having a low insertion loss for measuring a noise signal for each of wavelength channels. In another preferred embodiment, the apparatus further includes an optical channel power attenuation filter constituting a multi-wavelength Bragg grating filter with attenuated peaks matching a plurality of ITU channels and each of transmitted peaks having a low insertion loss for measuring a noise signal for each of wavelength channels. In another preferred embodiment, the narrow bandwidth notch filter is a temperature compensated fiber Bragg grating with at least one Bragg wavelength in each band; each Bragg wavelength matches one transmission peak of an optical channel power attenuation filter. In another preferred embodiment, the notch filter constituting a multi-channel optical power attenuation filter (MCOPAF) connected to a noise detector. And, the apparatus further includes an optical wavelength dependent tunable filter having a large FWHM with a reduced adjacent channel rejection for transmitting optical signal over a plurality of wavelength channels to the MCOPAF to accurately measure the noises transmitted in each channel. In another preferred embodiment, the notch filter constituting a multi-channel optical power attenuation filter (MCOPAF) connected to a noise detector. And, the apparatus further includes an optical wavelength dependent tunable filter for transmitting optical signal over a plurality of wavelength channels with a channel spacing ranged between 25 GHz to 100 GHz to the MCOPAF to accurately measure the noises transmitted in each channel. In another preferred embodiment, the notch filter constituting an multi-channel optical power attenuation filter (MCOPAF) connected to a noise detector, and the apparatus further includes an optical wavelength dependent tunable filter for transmitting optical signal over a plurality of wavelength channels to the MCOPAF and to a channel-power detector detection of a channel power and noise by a lower bandwidth electrical circuit for increasing a speed of detecting the channel power.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An optical signal quality monitoring system for monitoring an optical signal transmitted over an optical transmission system comprising:
a means for providing a calibration-spectrum for comparing with a measurement of said optical signal monitored for said optical transmission system for calibrating said measurement of said optical signal monitored for said optical transmission system.

2. The optical signal quality monitoring system of claim 1 wherein:
said means for providing a calibration-wavelength further comprising a standard light source and a notch filter for providing said calibration wavelength for comparing with said measurement of said optical signal monitored for said optical signal transmission system.

3. The optical signal quality monitoring system of claim 1 further comprising:
a first optical signal detecting means for measuring said optical signal monitored for said optical signal transmission system; and
a second optical signal detecting means for measuring said calibration-spectrum.

4. The optical signal quality monitoring system of claim 1 further comprising:
a first optical signal detecting means for measuring said optical signal monitored for said optical signal transmission system;
a second optical signal detecting means for measuring said calibration-spectrum; and
an optical switching means for transmitting alternate optical signals to said first and said second optical signal detection means.

5. The optical signal quality monitoring system of claim 1 further comprising:
a noise signal detecting means having an optical signal attenuation means for attenuating a portion of said optical signal monitored for said optical signal transmitting system for measuring said noise signal.

6. The optical signal quality monitoring system of claim 1 further comprising:
a spectrum-band selection means for selecting a band of spectrum of said optical signal monitored for said optical signal transmitting system.

7. The optical signal quality monitoring system of claim 1 further comprising:
an optical tunable filter for tuning and scanning over a plurality of wavelength-channels for detecting a quality of said optical signal for each of said wavelength-channels of said optical signal monitored for said optical signal transmitting system.

8. The optical signal quality monitoring system of claim 1 further comprising:
a noise signal detecting means having an optical signal attenuation means constituting a comb-attenuating filter for attenuating a peak of a plurality of wavelength-channels of said optical signal monitored for said optical signal transmitting system for measuring said noise signal.

9. The optical signal quality monitoring system of claim 1 wherein:
said means for providing said calibration-wavelength further comprising a calibrated Fabry-Perot comb filter wherein said comb filter is calibrated according to a relative insertion loss versus wavelengths and having a transmission curve similar to a SIN-wave function with a slope of middle points aligned to a standard ITU wavelength grid.

10. An optical signal quality monitoring system for monitoring an optical signal transmitted over an optical transmission system comprising:
a noise signal detecting means having an optical signal attenuation means for attenuating a portion of said optical signal monitored for said optical signal transmitting system for measuring said noise signal.

11. The optical signal quality monitoring system of claim 10 wherein:
said noise signal detecting means having an optical signal attenuation means constituting a comb-attenuating filter for attenuating a peak of a plurality of wavelength-channels of said optical signal monitored for said optical signal transmitting system for measuring said noise signal.

12. The optical signal quality monitoring system of claim 10 further comprising:
a means for providing a calibration-spectrum for comparing with a measurement of said optical signal monitored for said optical transmission system for calibration said measurement of said optical signal monitored for said optical transmission system.

13. An apparatus for analyzing an optical channel performance of a fiber optic system comprising:
a wavelength reference system having a broadband source connected to a narrow bandwidth notch filter for generating a notched spectrum having a notched optical power over a specific rang of wavelengths for providing a reference of wavelength measurement for said apparatus.

14. The apparatus of claim 13 further comprising:
an optical 2×1 switch to alternate between an input fiber and said broadband source for comparing two alternate measurements obtained in two alternate switching conditions of said 2×1 switch for using said wavelength reference system.

15. The apparatus of claim 13 further comprising:
an optical wavelength dependent tunable filter having an input and output;
a detection system for detecting a wavelength, power and optical noise of an optical signal providing from said optical output of said optical tunable filter; and
said output of said tunable filter splitted into at least into two branches wherein a first branch is for measuring a channel optical power and a second branch further includes an optical channel power attenuation means for measuring an optical noise and wavelength.

16. The apparatus of claim 13 further comprising:
an optical channel power attenuation filter constituting a periodic Fabry-Perot filter with attenuated peaks matching a plurality of ITU channels and each of transmitted peaks having a low insertion loss for measuring a noise signal for each of wavelength channels.

17. The apparatus of claim 13 further comprising:
an optical channel power attenuation filter constituting a multi-wavelength Bragg grating filter with attenuated peaks matching a plurality of ITU channels and each of transmitted peaks having a low insertion loss for measuring a noise signal for each of wavelength channels.

18. The apparatus of claim 13 wherein:
the narrow bandwidth notch filter is a temperature compensated fiber Bragg grating with at least one Bragg wavelength in each band; each Bragg wavelength matches one transmission peak of an optical channel power attenuation filter.

19. The apparatus of claim 13 wherein:
said notch filter constituting an multi-channel optical power attenuation filter (MCOPAF) connected to a noise detector; and
an optical wavelength dependent tunable filter having an increased full-width half-maximum and a reduced adjacent channel rejection for transmitting optical signal over a plurality of wavelength channels to said MCOPAF to accurately measure the noises transmitted in each channel.

20. The apparatus of claim 13 wherein:
said notch filter constituting an multi-channel optical power attenuation filter (MCOPAF) connected to a noise detector; and
an optical wavelength dependent tunable filter for transmitting optical signal over a plurality of wavelength channels with a channel spacing ranged between 25 GHz to 100 GHz to said MCOPAF to accurately measure the noises transmitted in each channel.

21. The apparatus of claim 13 wherein:
said notch filter constituting an multi-channel optical power attenuation filter (MCOPAF) connected to a noise detector; and
an optical wavelength dependent tunable filter for transmitting optical signal over a plurality of wavelength channels to said MCOPAF and to a channel-power detector detection of a channel power and noise by a lower bandwidth electrical circuit for increasing a speed of detecting said channel power.
